(19) United States
(12) Patent Application Publication
(10) Pub. No.: US 2008/0130318 A1
(43) Pub. Date: Jun. 5, 2008

(54) BACKLIGHT UNIT

(76) Inventors: Seong-Ha Park, Suwon-si (KR); Joong-Wan Park, Suwon-si (KR); Man-Ho Kim, Suwon-si (KR)

Correspondence Address: CHA & REITER, LLC, 210 ROUTE 4 EAST STE 103, PARAMUS, NJ, 07652, US

(21) Appl. No.: 11/949,805

(22) Filed: Dec. 4, 2007

(30) Foreign Application Priority Data
Dec. 4, 2006 (KR) 121519/2006

(51) Int. Cl. F21V 7/04

(52) U.S. Cl. 362/620

(57) ABSTRACT

A backlight unit (BLU) includes a Light Guide Panel (LGP) having an upper surface and a lower surface facing each other. The LGP waveguides light input into the inside of the LGP by means of internal reflection between the upper surface and the lower surface. A prism sheet, which is disposed on the LGP, concentrates and transmits light input from the LGP. The prism sheet includes first prism mountains, which are formed on the surface of the prism sheet and transmit and concentrate the light input from the LGP, and second prism mountains, which are formed on the surface of the prism sheet, to cross the first prism mountains and transmit and concentrate the light input from the LGP.

### CLAIM OF PRIORITY

This application claims the benefit of priority under 35 U.S.C. § 119(a) from a Patent Application filed in the Korean Intellectual Property Office on Dec. 4, 2006 and assigned Serial No. 2006-121519, the contents of which are incorporated herein by reference in its entirety.

### BACKGROUND OF THE INVENTION

1. Field of the Invention

The present invention relates generally to a backlight unit (BLU) for a flat display device. More particularly, the present invention relates to a BLU using a Light Guide Panel (LGP).

2. Description of the Related Art

A Liquid Crystal Display (LCD) device, which is a representative flat display device, is one of a type of light receiving display devices that do not emit light by themselves. That is, unlike a self light emitting display device, such as a Plasma Display Panel (PDP) or a Field Emission Display (FED), the LCD device is a display device requiring light from the outside. These light receiving display devices typically require a backlight unit (BLU) for uniformly illuminating the entire surface.

FIG. 1 is a side view of a conventional BLU 100. Referring to FIG. 1, the BLU 100 includes a reflecting panel 140, a light source 130, a Light Guide Panel (LOP) 110, first and second diffusing panels 150 and 180, and first and second prism sheets 160 and 170. In the shown coordinates, a 7-axis is parallel to an illumination direction of the BLU 100 (in other words, parallel to a normal of an upper surface 114 of the LGP 110), an X-axis is parallel to a traveling direction of light output from the light source 130, and a Y-axis is parallel to a direction perpendicular to both the X-axis and the Z-axis.

The LGP 110 has the upper surface 114 and a lower surface 112 facing each other (in other words, located in either side of the LGP 110) and first and second sides 116 and 118 facing each other. The light source 130 faces the first side 116 of the LOP 110 and outputs light towards the first side 116. The LGP 110 acts as a waveguide for the light input therein via the first side 116 towards the second side 118 by means of internal reflection between the upper surface 114 and the lower surface 112.

Still referring to FIG. 1, the LGP 110 also has a plurality of dot patterns 120 uniformly arranged all over the lower surface 112. Each dot pattern 120 is implemented by a semi-spherical groove and reflects and diffuses incident light. That is, each dot pattern 120 destroys the total internal reflection condition on a boundary between the LGP 110 and an external air layer so that the light reflected and diffused by the dot pattern 120 is transmitted through the upper surface 114 of the LGP 110. According to a luminance distribution appearing on the upper surface 114 of the LGP 110, luminance at a viewing angle of 0° is very low, and luminance at a high viewing angle is very high. When the viewing angle is 0°, an observer views the BLU 100 in a direction parallel to the Z-axis. The ‘diffusion’ in the present invention contains diffused reflection (or scattering) on a non-optical surface, mirror reflection on a non-plane, and the like.

In the conventional BLU shown in FIG. 1, the reflecting panel 140 is disposed so that an upper surface of the reflecting panel 140 faces the lower surface 112 of the LGP 110, and reflects the light transmitted through the lower surface 112 of the LGP 110 so that the light goes back inside the LGP 110.

The first diffusing panel 150 is disposed so that a lower surface of the first diffusing panel 150 faces the upper surface 114 of the LGP 110, and scatters and transmits incident light. The first and second diffusing panels 150 and 180 disperse a luminance distribution concentrated on a high viewing angle towards a low viewing angle by scattering incident light.

The first prism sheet 160 is disposed so that a lower surface of the first prism sheet 160 faces an upper surface of the first diffusing panel 150, and includes a substrate 162 and a plurality of prism mountains 164, which protrude from an upper surface of the substrate 162 and are away in parallel to each other. The plurality of prism mountains 164 extend in parallel to the X-axis (in other words, in parallel to a normal of the first side 116 of the LGP 110). The first prism sheet 160 concentrates and transmits incident light on a cross-sectional plane thereof (in other words, a Y-Z plane or a plane perpendicular to a length direction of the first prism sheet 160). The first and second prism sheets 160, 170 provide a luminance distribution to be concentrated on low viewing angles.

The second prism sheet 170 is disposed so that a lower surface of the second prism sheet 170 faces an upper surface of the first prism sheet 160, and includes a substrate 172 and a plurality of prism mountains 174, which protrude from an upper surface of the substrate 172 and are away in parallel to each other. Each prism mountain 174 of the second prism sheet 170 extends in parallel to the Y-axis (in other words, in perpendicular to the normal of the first side 116 of the LGP 110). The second prism sheet 170 concentrates and transmits incident light on a cross sectional plane thereof (in other words, an X-Z plane or a plane perpendicular to a length direction of the second prism sheet 170).

The second diffusing panel 180 is disposed so that a lower surface of the second diffusing panel 180 faces an upper surface of the second prism sheet 170, and functions to scatter and transmit incident light.

However, the conventional BLU 100 described above and shown in FIG. 1 has the following problems.

First, as the BLU 100 requires two expensive prism sheets 160 and 170, a manufacturing cost is high and a thickness of the BLU 100 is large. If only one prism sheet 160 or 170 is used, the luminance of the BLU 100 may significantly decrease to around a half of that of sheets.

Second, as the light transmitted through the upper surface 114 of the LGP 110 suffers from an optical insertion loss while being transmitted through the first and second prism sheets 160 and 170, optical efficiency is low. In addition, due to the multi-reflection of light, which occurs between the first and second prism sheets 160 and 170, a damage may occur in the external appearance, such as Moire fringes.

### SUMMARY OF THE INVENTION

One of the many aspects of the present invention is to substantially solve in part at least some of the above problems and/or disadvantages and to provide at least the advantages disclosed herein below. Accordingly, an exemplary aspect of the present invention is to provide a backlight unit (BLU) for improving optical efficiency, economic feasibility, and an external appearance characteristic unknown heretofore.

According to one exemplary aspect of the present invention, there is provided a backlight unit (BLU) comprising: a Light Guide Panel (LGP) having an upper surface and a lower surface facing each other, and a waveguiding light input into the inside of the LGP by means of internal reflection between the upper surface and the lower surface; a prism sheet, which is disposed on the LGP and concentrates and transmits light input from the LGP, wherein the prism sheet comprises: first prism mountains, which are formed on the surface of the prism sheet and transmit and concentrate the light input from the LGP; and second prism mountains, which are formed on the surface of the prism sheet to cross the first prism mountains and transmit and concentrate the light input from the LGP.

### BRIEF DESCRIPTION OF THE DRAWINGS

The above and other aspects, features and advantages of the present invention will become more apparent from the following detailed description when taken in conjunction with the accompanying drawing in which:

FIG. 1 is a side view of a conventional backlight unit (BLU);

FIG. 2 is a side view of a BLU according to an embodiment of the present invention;

FIG. 3 shows cross-sectional views of a dot pattern having a circular edge;

FIG. 4 shows an exemplary distribution of dot patterns having a density variation;

FIG. 5 is a top view of an upper surface of a prism sheet illustrated in FIG. 2;

FIG. 6 illustrates first and second prism mountains illustrated in FIG. 2; and

FIG. 7 is a side view of a BLU according to another embodiment of the present invention.

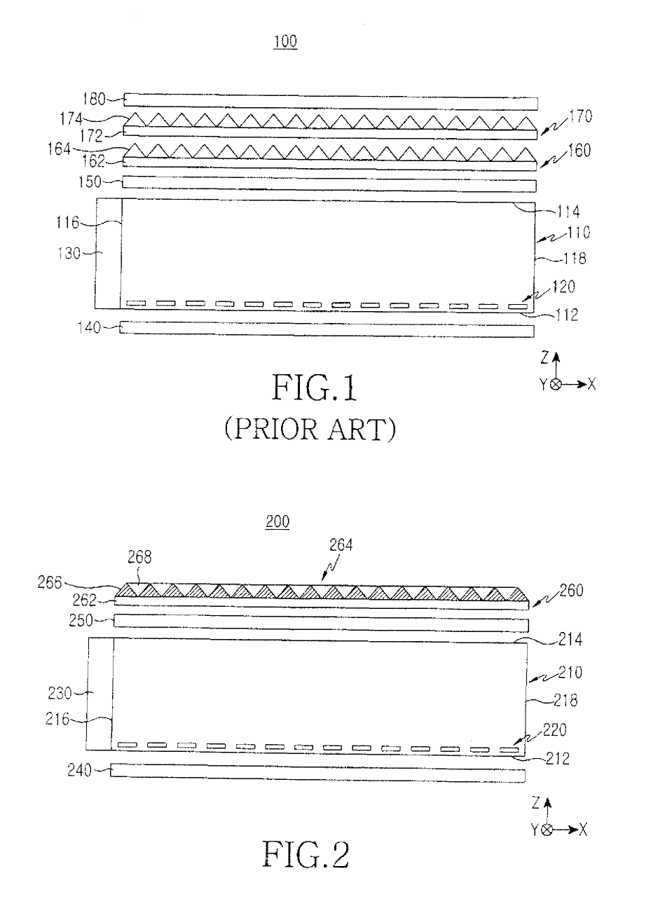

### DETAILED DESCRIPTION OF THE INVENTION

Now, embodiments of the present invention will be described herein below with reference to the accompanying drawings. For the purposes of clarity and simplicity, well-known functions or constructions may not be described in detail as such well-known functions or constructions would obscure appreciation of the invention.

FIG. 2 is a side view of a backlight unit (BLU) 200 according to a first embodiment of the present invention. Referring to FIG. 2, the BLU 200 includes a reflecting panel 240, a light source 230, a light Guide Panel (LGP) 210, a diffusing panel 250, and a prism sheet 260. In the shown coordinates, a Z-axis is parallel to an illumination direction of the BLU 200 (in other words, parallel to a normal of an upper surface 214 of the LGP 210), an X-axis is parallel to a traveling direction of light output from the light source 230, and a Y-axis is parallel to a direction perpendicular to the X-axis and the Z-axis.

In the example shown in FIG. 2, the LGP 210 has an upper surface 214 and a lower surface 212 facing each other, and first and second sides 216 and 218 facing each other. The light source 230 is adjacent and faces the first side 216 of the LGP 210 and outputs light towards the first side 216. The light source 230 may include devices such as A Light Emitting Diode (LED), a Laser Diode (LD), a lamp, or the like. The LGP 210 waveguides the light input therein via the first side 216 towards the second side 218 by means of internal reflection between the upper surface 214 and the lower surface 212. The LGP 210 also has a plurality of dot patterns 220 arranged/formed on the lower surface 212. Each dot pattern 220 may include various edge patterns, such as a circle, an oval, a quadrangle, a lozenge, and so on, and can be formed in the form of an intaglio (in other words, a groove pattern, carve out, etc.) or embossing (in other words, a protrusion pattern). In addition, each dot pattern 220 may be individually formed in the protrusion pattern and attached to the lower surface 212 of the LGP 210. Each dot pattern 220 can be preferably implemented in the form of a semi-spherical groove. If necessary, each dot pattern 220 may be implemented by a diffused reflection pattern, such as a scratch.

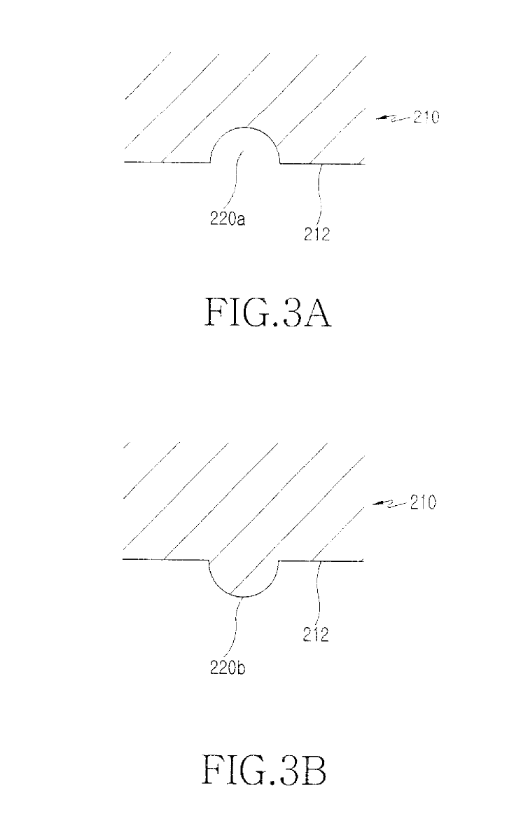

FIG. 3 shows cross-sectional views of an exemplary dot pattern having a circular edge. FIG. 3A shows a dot pattern 220a having a circular edge, which is engraved in intaglio on the lower surface 212 of the LGP 210, and FIG. 3B shows a dot pattern 220b having a circular edge, which is engraved in relief on the lower surface 212 of the LGP 210. A person of ordinary skill in the art understands and appreciates that the dot patterns shown in FIGS. 3A and 3B could be in the shape desired, included but not limited to the examples disclosed above.

Referring back to FIG. 2, each dot pattern 220 reflects and diffuses incident light. In other words, each dot pattern 220 destroys the total internal reflection condition on a boundary between the LGP 210 and an external air layer so that the light reflected and diffused by the dot pattern 220 is transmitted through the upper surface 214 of the LGP 210.

Since light in the LGP 210 is attenuated while traveling from the first side 216 adjacent to the light source 230 to the second side 218, a luminance distribution appearing on the upper surface 214 of the LGP 210 gradually decreases in a direction from the first side 216 to the second side 218. In order to solve this luminance non-uniformity, according to the present invention, the density of the dot patterns 220 can be gradually increased in the direction from the first side 216 to the second side 218. A density variation of the dot patterns 220 can be implemented by varying the number of dot patterns 220 or each size of the dot patterns 220, and the density of the dot patterns 220 can be defined as an area occupied by the dot patterns 220 per unit area.

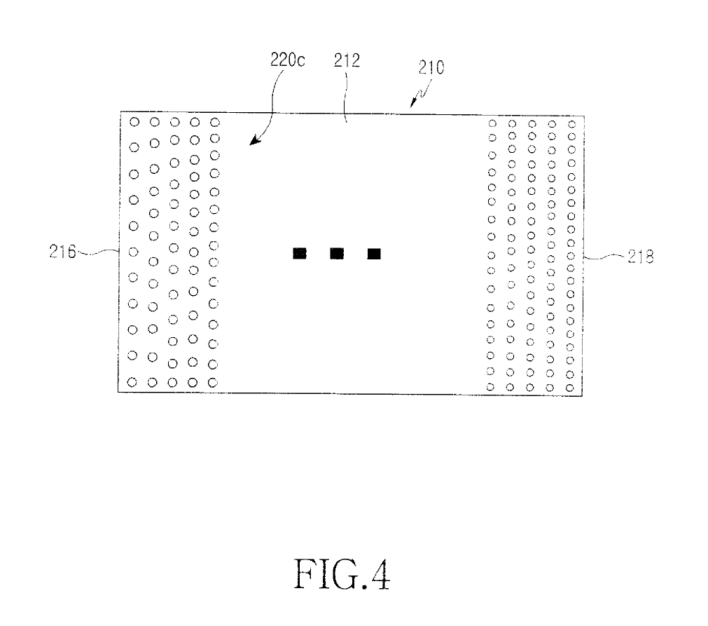

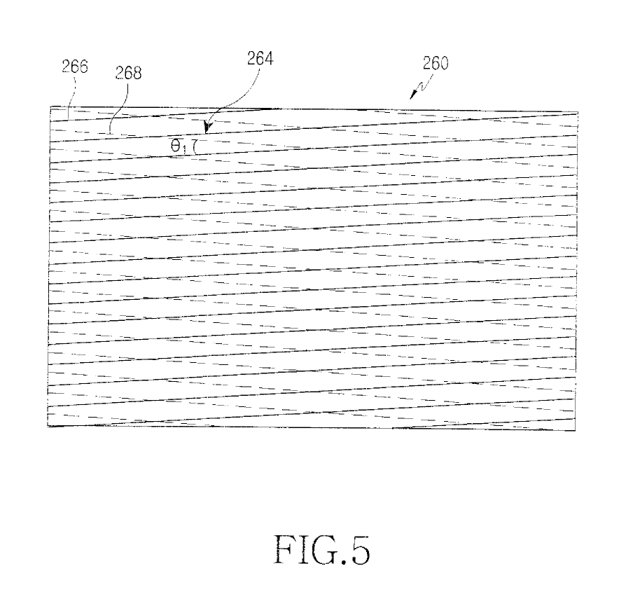

FIG. 4 shows an exemplary distribution of dot patterns having a density variation. As illustrated in FIG. 4, dot patterns 220c formed on the lower surface 212 of the LGP 210 have the same form and size, and the number of dot patterns 220c per unit area gradually increases in the direction from the first side 216 of the LGP 210 to the second side 218.

Now referring back to FIG. 2, the reflecting panel 240 is disposed so that an upper surface of the reflecting panel 240 faces the lower surface 212 of the LGP 210, and reflects the light transmitted through the lower surface 212 of the LGP 210 so that the light goes back inside the LGP 210. Although the reflecting panel 240 has a reflection rate close to 100%, the reflecting panel 240 may have a lower reflection rate, if necessary or desired. For example, although the BLU 200 provides single directional illumination in the current exemplary embodiment, the BLU 200 maybe used to provide bi-directional illumination. In such a case, the reflection rate of the reflecting panel 240 may be set to between 50˜80%, and a diffusing panel and another prism sheet may be further sequentially disposed below the reflecting panel 240.

The diffusing panel 250 is disposed so that a lower surface of the diffusing panel 250 faces the upper surface 214 of the LGP 210, and scatters and transmits light input from the LGP 210. The diffusing panel 250 disperses a luminance distribution concentrated on a high viewing angle towards a low viewing angle by scattering the input light.

The prism sheet 260 is disposed so that a lower surface of the prism sheet 260 faces an upper surface of the diffusing panel 250, and includes a substrate 262 and a prism pattern 264 formed on an upper surface of the substrate 262. The prism pattern 264 has a repeated ‘X’ pattern, i.e., a rectangular check pattern, and more preferably, may have a lozenge-shaped check pattern. The prism pattern 264 transmits and concentrates light input from the diffusing panel 250.

FIG. 5 is a top (plan) view of an upper surface of the prism sheet 260 illustrated in FIG. 2. Referring to FIG. 5, the prism pattern 264 includes first prism mountains 266 and second prism mountains 268. The first prism mountains 266 are typically periodically formed to have a uniform pitch in parallel to each other, and are formed away from each other or continuously. Each first prism mountain 266 extends long in a direct line type and transmits and concentrates incident light on a cross-sectional plane of the first prism mountain 266 (in other words, a plane perpendicular to a length direction of each first prism mountain 266). The second prism mountains 268 are typically formed to cross the first prism mountains 266, periodically formed to have a uniform pitch, and formed away from each other or continuously.

Still referring to FIG. 5, each second prism mountain 268 extends long in a direct line type and transmits and concentrates incident light on a cross-sectional plane of the second prism mountain 268 (in other words, a plane perpendicular to a length direction of each second prism mountain 268). The first and second prism mountains 266 and 268 are formed in the form of protrusion from the upper surface of the substrate 262. Each of the first and second prism mountains 266 and 268 typically has a pitch less than about 0.3 mm. A relatively small included angle θ₁ between the first and second prism mountains 266 and 268 is typically within a range of about 2˜40°, and a relatively small included angle between the X-axis and the length direction of each of the first and second prism mountains 266 and 268 is typically within a range of about 1˜20°.

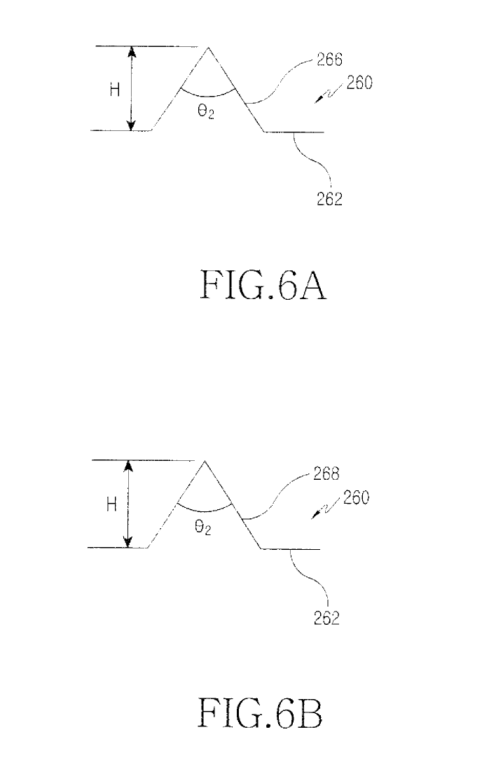

FIG. 6 provides detail of the first and second prism mountains 266 and 268 illustrated in FIG. 2. FIG. 6A is a cross-sectional diagram of the first prism mountain 266, and FIG. 6B is a cross-sectional diagram of the second prism mountain 268. The first and second prism mountains 266 and 268 have the same form, each prism mountain having a prism angle θ₂ typically within a range of about 60˜120° and a height H typically within a range of about 2˜20 μm. In this example, each of the first and second prism mountains 266 and 268 typically correspond in appearance to an isosceles triangle. Although each of the first and second prism mountains 266 and 268 has an angular apex, each of the first and second prism mountains 266 and 268 may have a round apex according to a pre-set change if necessary.

As described above, a BLU according to an exemplary embodiment of the present invention may also be used for bi-directional illumination.

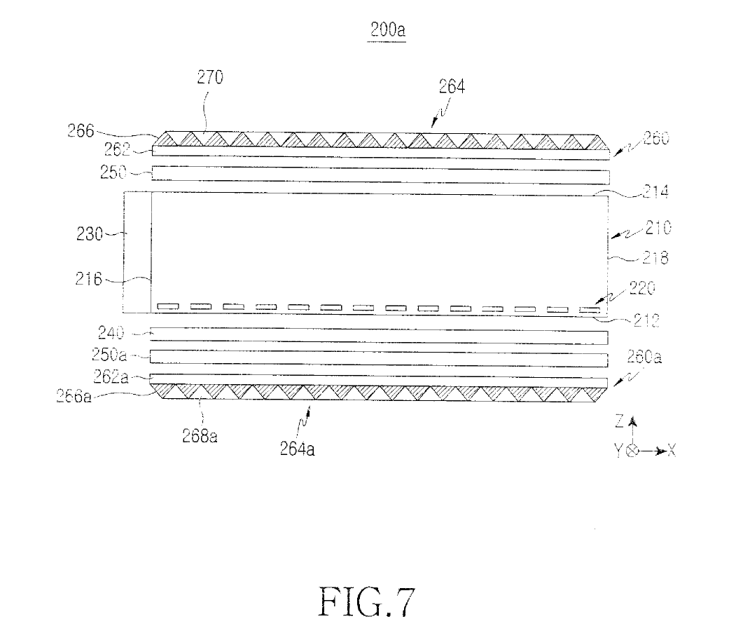

FIG. 7 is a side view of a BLU 200a according to a second embodiment of the present invention. Since the BLU 200a illustrated in FIG. 7 includes all elements of the BLU 200 illustrated in FIG. 2 and has at least a difference in that one more diffusing panel and prism sheet are further included, wherein the same elements are denoted by the same reference numerals and duplicated description is omitted. Referring to FIG. 7, the BLU 200a includes a reflecting panel 240, a light source 230, an LGP 210, first and second diffusing panels 250 and 250a, and first and second prism sheets 260 and 260a.

According to the example shown in FIG. 7, the reflecting panel 240 is typically disposed so that an upper surface of the reflecting panel 240 faces the lower surface 212 of the LGP 210, and has a typically reflection rate of about 50˜80%. The reflecting panel 240 reflects a portion of the light transmitted through the lower surface 212 of the LGP 210 so that the portion of light goes back inside the LGP 210, and transmits the other portion of the light transmitted through the lower surface 212 of the LGP 210.

The second diffusing panel 250a is disposed so that an upper surface of the second diffusing panel 250a faces a lower surface of the reflecting panel 240, and scatters and transmits the light transmitted through the reflecting panel 240. The second diffusing panel 250a scatters the incident light so that a luminance distribution concentrated on at a higher viewing angle towards a lower viewing angle.

The second prism sheet 260a is typically disposed so that an upper surface of the second prism sheet 260a faces a lower surface of the second diffusing panel 250a, and includes a substrate 262a and a prism pattern 264a formed on a lower surface of the substrate 262a. The prism pattern 264a may have a repeated ‘X’ pattern. The prism pattern 264a transmits and concentrates light input from the second diffusing panel 250a. The prism pattern 264a includes first prism mountains 266a and second prism mountains 268a. The first prism mountains 266a are periodically formed to have a uniform pitch in parallel to each other, and are formed away from each other or continuously. Each first prism mountain 266a extends long in a direct line type and transmits and concentrates incident light on a cross-sectional plane of the first prism mountain 266a (in other words, a plane perpendicular to a length direction of each first prism mountain 266a). The second prism mountains 268a are formed to cross the first prism mountains 266a, periodically formed to have a uniform pitch, and formed away from each other or continuously. Each second prism mountain 268a extends long in a direct line type and transmits and concentrates incident light on a cross-sectional plane of the second prism mountain 268a (in other words, a plane perpendicular to a length direction of each second prism mountain 268a). The first and second prism mountains 266a and 268a are formed in the form of protrusion from the upper surface of the substrate 262a. Each of the first and second prism mountains 266a and 268a typically has a pitch less than about 0.3 mm. A relatively small included angle between the first and second prism mountains 266a and 268a is typically within a range of about 2˜40°, and a relatively small included angle between the X-axis and the length direction of each of the first and second prism mountains 266a and 268a is typically within a range of about 1˜20°.

As shown and described in the above examples, according to the present invention, as only one prism sheet is used for one illumination direction, the advantages include a decrease of thickness of the device, a decrease in price, an increase of optical efficiency, and an increase of luminance, as compared to the conventional BLU.

In addition, as only one prism sheet is used for one illumination direction, additional advantages, such as a decrease of Moire fringes and a decrease of color breakup effect, can also be obtained as compared to the conventional BLU.

In addition, since the thickness of a BLU is thinner compared to the prior art, the BLU is more suitable for portable terminals, such as cellular phones, than the conventional BLU.

While the invention has been shown and described with reference to a certain preferred exemplary embodiments thereof, it will be understood by those skilled in the art that various changes in form and details may be made therein without departing from the spirit of the invention and the scope of the appended claims.

What is claimed is:

1. A backlight unit (BLU) comprising:
a Light Guide Panel (LGP) having an upper surface and a lower surface opposite each other, said LGP waveguiding light input into the inside of the LGP by means of internal reflection between the upper surface and the lower surface; and
a single prism sheet, which is disposed on the LGP, having a repeated ‘X’ pattern on one surface thereof, and concentrates and transmits light input from the LGP.

2. The BLU of claim 1, where said LGP includes a first side and a second side arranged substantially perpendicular to the upper surface and lower surface, and said BLU further comprises a light source arranged adjacent to the first side of the LGP for providing light, of which a portion reflects between the upper surface and the lower surface while traveling toward the second side.

3. The BLU of claim 1, wherein the prism sheet comprises:
first prism mountains, which are formed on the surface of the prism sheet and transmit and concentrate the light input from the LGP; and
second prism mountains, which are formed on the surface of the prism sheet to cross the first prism mountains and transmit and concentrate the light input from the LGP.

4. The BLU of claim 1, further comprising a diffusing panel, which is disposed between the LGP and the prism sheet and scatters and transmits incident light.

5. The BLU of claim 1, further comprising a reflecting panel, which is disposed below the LGP and reflects light transmitted through the lower surface of the LGP.

6. The BLU of claim 5, further comprising a second diffusing panel disposed so that an upper surface of the second diffusing panel faces a lower surface of the reflecting panel, said second diffusing panel for scattering and transmitting light transmitted through the reflecting panel; and
a second single prism sheet, disposed so that an upper surface of the second prism sheet faces a lower surface of the second diffusing panel.

7. The BLU of claim 1, wherein the LGP comprises a plurality of dot patterns, which are formed on the lower surface of the LGP and reflect and diffuse incident light.

8. The BLU of claim 7, wherein the dot patterns comprise at least one of a circle, an oval, a quadrangle, and a lozenge.

9. The BLU of claim 8, wherein the dot patterns are formed in the form of an intaglio.

10. The BLU of claim 8, wherein the dot patterns are embossed.

11. The BLU of claim 8, wherein the dot patterns are separately formed and attached to the lower surface of the LGP.

12. The BLU of claim 7, wherein density of the dot patterns gradually increases in a direction from a first side of the LOP to a second side of the LGP opposing to the first side.

13. The BLU of claim 3, wherein each of the first and second prism mountains has a pitch less than about 0.3 mm.

14. The BLU of claim 3, wherein an included angle between the first and second prism mountains is within a range of about 2˜40°.

15. The BLU of claim 3, wherein each of the first and second prism mountains has a prism angle within a range of about 60˜120° and a height within about 2-20 μm.

16. The BLU of claim 3, wherein the first prism mountains are periodically formed to have a uniform pitch in parallel to each other.

17. The BLU of claim 3, wherein the second prism mountains are periodically formed to have a uniform pitch in parallel to each other.
